(19) United States
(12) Patent Application Publication
(10) Pub. No.: US 2004/0078730 A1
(43) Pub. Date: Apr. 22, 2004

(54) Data error detection method, apparatus, software, and medium

(76) Inventors: Qing Ma, Tokyo (JP); Bao-Liang Lu, Saitama (JP)

Correspondence Address: BIRCH STEWART KOLASCH & BIRCH, PO BOX 747, FALLS CHURCH, VA, 22040-0747, US

(21) Appl. No.: 10/216,214

(22) Filed: Aug. 12, 2002

(30) Foreign Application Priority Data
Aug. 15, 2001 (JP) 2001-246642

(51) Int. Cl. G06F 11/00

(52) U.S. Cl. 714/54

(57) ABSTRACT

The aim of this invention is to provide a fast, highly efficient, and highly accurate data error detection method for a database that includes at least two types of data and in which one type of data can be classified by another type of data. The classification in the database is regarded as a class in a neural network. The original classification problem is divided into smaller two-class subproblems to provide a number of modules, and calculation is made to check whether or not each of the said module converges in the learning process in the neural network. If a module does not converge, the module is regarded as having pattern classification errors and is then extracted.

### BACKGROUND OF THE INVENTION

1. Technical Field

This invention relates to a data error detection method, its apparatus, software, and the medium thereof for use in databases, or, more specifically, to technology for detecting errors at high speed and with high efficiency and accuracy.

2. Related Art

In general, a database contains two or more kinds of data and is often organized so that the data of one certain type is classified by the data of another type.

It is almost inevitable that a man-made database contains errors, and yet error detection is very difficult to perform, particularly in large-scale databases.

Although a variety of error detection methods have been proposed, high speed, high efficiency, and highly accurate methods are quite limited in number. In particular, there are very few detection methods that are generally applicable to a wide range of fields.

The text corpora used in the training processes of language processing systems are examples of large-scale databases. Since many of the text corpora are manually constructed they contain numerous errors, and those errors often impede the progress of research and reduce the accuracy of language processing. Therefore, the detection and correction of errors in a text corpus is a challenge of great importance.

One of the conventional methods for detecting errors in a text corpus is a method using example-base technique and decision list technique, which calculates the error probability from the target corpus alone for error detection. (Reference: Murata, M., Uchiyama, M., Uchimoto, K., Ma, Q., and Isahara, H.: Corpus Error Detection and Correction Using the Decision-List and Example-Based Methods, 2000-NL-136, pp.49-56, 2000).

According to conventional methods, however, an error detection method suitable for each of the target text corpora must be developed, and error detection must be carried out sequentially for all databases. Such an approach is time consuming and costly, and a high degree of accuracy is not always attained.

Additionally, error detection can only be carried out after the construction of the database, and it is impossible to detect errors on an on-line basis during construction by conventional techniques.

Thus the need exists for developing an error detection method for databases that can detect errors at high speed and with high efficiency and accuracy.

### SUMMARY OF THE INVENTION

This invention provides the following data error detection method in order to solve the problems mentioned above, as well as other more conventional difficulties.

Firstly, the databases that will be the target of the present invention are those that contain at least two kinds of data and in which one kind of data can be classified by another kind of data.

In the present invention, the classification is regarded as a class in a neural network and divided into relatively smaller two-class problems to provide a plurality of modules. Then a calculation is made to check whether each of the modules converges in the learning process in the neural network or not. Unless it converges, the module is regarded as containing pattern classification errors, and this module is then extracted.

The present invention is capable of detecting the location of the data error, and can also provide a data error detection apparatus. Specifically, the data error detection apparatus comprises:

(1) a means for memorizing said database;

(2) a means of calculation for treating the classification as a class in the neural network, dividing the classification problem into smaller two-class problems for providing a plurality of modules, making calculations to check whether each of the said modules converges in the learning process in the neural network or not; and

(3) a means of error extraction for regarding said modules as having pattern classification errors in case of convergence failure and then extracting such modules.

Furthermore, the present invention can provide the following software program. This software program includes the steps for treating the classification as a class in the neural network and dividing the classification problem into smaller two-class problems for providing a plurality of modules, making calculations to check whether each of the said modules converges in the learning process in the neural network or not, and, regarding said module as having pattern classification errors in case of convergence failure, extracting the said module.

In addition, the present invention can provide a memory medium storing the above-mentioned error detection software program.

### BRIEF DESCRIPTION OF THE DRAWINGS

FIG. 1 is a diagram illustrating the M³ network used in Embodiment-1: FIG. 1A illustrating its overall structure; and FIG. 1B illustrating the details of Module M_{7,26}.

FIG. 2 is an example of error detection for examining the results of Embodiment-1 in accordance with the present invention.

FIG. 3 is a non-average single-trial EEG signal.

FIG. 4 is a diagram illustrating the data distributions of training and test data.

FIG. 5 is a diagram illustrating the time-frequency contour maps of four EEG signals.

### DETAILED DESCRIPTION OF THE PREFERRED EMBODIMENTS

### Embodiment-1

Embodiment-1 is an example of adopting the error detection method of the present-invention as an error detection system for a text corpus.

Although a Japanese corpus is employed as an example of text corpora in the following description, the embodiment of the present invention is effective in any language, such as English, Chinese, and Korean, except for a few cases where it is logically inapplicable. The target of the present invention may be text corpora including any word information such as parts of speech and morphemes. The error detection method of the present invention is able to detect errors relevant to this word information.

When processing sentences of a variety of natural languages with machines, it is almost impossible to encode all necessary knowledge in advance. One solution to this problem is a direct compiling of knowledge that the machine system needs from a large-scale database of natural language sentences where several kinds of tags, such as part-of-speech (POS) and syntax dependence, have been added, as opposed to using databases of plain sentences alone.

Corpora have been often used to construct a variety of basic natural language processing systems, including complex word analyzers and parsers. Such systems can be applied to many fields of information processing, such as pre-processing for voice synthesis, post-processing for OCR, and voice recognition, machine translation, information retrieval, and sentence summarization.

Manual tagging on a large-scale corpus is, however, a very complex and costly job; the Penn Tree Bank, for example, consists of more than 4.5 million words and 135 types of POS.

Therefore, a number of automatic POS tagging systems using diverse machine learning techniques have been proposed to date (for example, see References [1,2]).

Reference [1]: Merialda, B.: Tagging English text with a probabilistic model, Computational Linguistics, Vol.20, No.2, pp.155-171, 1994.

Reference [2]: Brill, E.: Transformation-based error-driven learning and natural language processing: a case study in part-of-speech tagging, Computational Linguistics, Vol.21, No.4, pp.543-565, 1994.

In previous research we developed a neuro/rule-based hybrid tagger. This tagging system has reached the level at which it can be put into practical use (see Reference [3]) in terms of tagging accuracy and minimized training data.

Reference [3]: Ma, Q., Uchimoto, K., Murata, M., and Isahara, H.: Hybrid neuro and rule-based part of speech taggers, Proc.COLING'2000, Saarbrucken, pp.509-515, 2000.

There are two approaches to the improvement of tagging accuracy in this tagging system. One is to increase the amount of training data, and the other is to improve the quality of the corpus that is used for training.

The first approach is, however, accompanied with a problem of non-convergence because it uses a multilayer perceptron in the tagger. To overcome this intrinsic problem, we have developed a min-max module (M³) neural network (see Reference [4]).

Reference [4]: Lu, B. L. and Ito, M.: Task decomposition and module combination based on class relations; a modular neural network for pattern classification, IEEE Trans. Neural Networks, Vol.10, No.5, pp.1244-1256, 1999.

This is a network for breaking down a large-scale, complex problem into a number of relatively smaller and simpler subproblems for solution (see Reference [5]).

Reference [5]: Lu, B. L., Ma, Q., Isahara, H., and Ichikawa, M.: Efficient part-of-speech tagging with a min-max module neural network model, to appear in Applied Intelligence, 2001.

Thus it will be possible to adopt the POS error detection method as the second approach for detecting errors in corpora. The present invention can provide an error detection method based on this approach, and the following is a detailed description about how to implement such a method.

Since words are often ambiguous in terms of POS, they have tobe clarified (tagged) with reference to context. Regardless of whether it is an automatic or manual method, the tagging work usually contains errors.

There are basically three types of errors in the POS of a manually tagged corpus: a simple error (for example, “Varb” is entered for POS “Verb”); an inaccurate knowledge error (for example, the word “fly” is always tagged as a “verb”); and an inconsistency error (for example, “like” in the sentence “Time flies like an arrow” is correctly tagged as a “preposition”, but in the sentence “The one like him is welcome” it is tagged as a “verb”).

Simple errors can be easily detected by referring to a dictionary. On the other hand, inaccurate knowledge errors are almost impossible to spot with an automatic method. If tagging of a word with correct POS is regarded as a classification problem or a context-based POS input/output word mapping problem, then the inconsistency error can be considered as a collection of identical-input/different-output (class) data. Therefore, such errors can be dealt with by a neural network technique that the present invention proposes.

The M³ network consists of modules designed to deal with very simple subproblems. These modules can be composed of very simple multilayer perceptrons, using few or no hidden units.

This implies that there is basically no concern for non-convergence problems in such modules. In others words, unless a module converges, we can assume that basically such a module is trying to learn data including inconsistent-type errors.

Therefore, as the detection process proceeds along with a learning process or the non-convergent module is extracted for finding inconsistent data included in the target data set for learning, such errors in a tagged corpus can be detected online. When using a high-quality corpus, the number of non-convergent modules is more limited than that of convergent ones, and the data set that each module learns is very small. Consequently, this online error detection method provides significant cost benefit, particularly for large-scale corpora.

Through the use of such an online error detection method, the corpus quality is promptly improved by simple manual operations during learning, and the updated data promptly serves the re-learning of other non-convergent modules.

An outline of the M³ network follows, including a technique for dividing a large-scale, complex K-class problem into a number of relatively simpler, smaller subproblems that can be solvedby using respective independent modules, and also a technique for combining those modules to provide the final solution.

Let T be the training set for a K-class classification problem,

$$T = {\{ ( {X}_{l} , {Y}_{l} ) \}}_{l = 1}^{L} , \qquad Eq . 1$$

where XₗIRⁿ is the input vector, YₗIR^{k} is the desired output, and L is the total number of training data. Generally, a K-class problem can be divided into (K/2) two-class problems.

$${T}_{i j} = {\{ ( {X}_{l}^{( i )} , 1 - ε ) \}}_{l = 1}^{{L}_{i}} ⋃ {\{ ( {X}_{l}^{( j )} , ε ) \}}_{l = 1}^{{L}_{j}} , i = 1 , … , K , j = i + 1 , … , K \qquad Eq . 2$$

where ε is a small positive real number, and Xₗ⁽ⁱ⁾ and Yₗ^{(j)} are the input vectors belonging to class Cₗ and class Cⱼ, respectively.

A problem among the (K/2) two-class problems, which is still complex even after division, can be further broken down. A grand set of input vectors belonging to each class, for example, Xₗ⁽ⁱ⁾ (see Eq. 2), is randomly divided into as many as Nᵢ(1≦Nᵢ≦Lᵢ) subsets χᵢⱼ. Namely,

$${χ}_{i j} = {\{ {X}_{l}^{( i j )} \}}_{l = 1}^{{L}_{i}^{( j )}} , j = 1 , … , {N}_{i} , \qquad Eq . 3$$

where Lₗ^{(j)} is the number of input vectors in subset χᵢⱼ. Using such subsets, the two-class problem defined in Eq. 2 can be divided into Nₗ×Nⱼ relatively smaller and simpler two-class subproblems.

$${T}_{i j}^{( u , v )} = {\{ ( {X}_{l}^{( i u )} , 1 - ε ) \}}_{l = 1}^{{L}_{i}^{( u )}} ⋃ {\{ ( {X}_{l}^{( j v )} , ε ) \}}_{l = 1}^{{L}_{j}^{( v )}} , u = 1 , … , {N}_{i} , v = i , … , {N}_{j} , \qquad Eq . 4$$

where Xₗ^{(lu)}Iχₗᵤ and Xₗ^{(jv)}Iχⱼᵥ are the elements belonging to class Cᵢ and class Cⱼ, respectively.

Therefore, if the two-class problem defined by Eq. 2 is divided into subproblems defined by Eq. 4, then the original K-class problem can be divided into two-class problems of as many as:

$${\sum }_{i = 1}^{K} {\sum }_{j = i + 1}^{K} {N}_{i} \times {N}_{j}$$

If the data set to be learned contains only two elements, namely, Lₗ=1^{(u)} and Lⱼ^{(v)}=1, the two-class problem defined by Eq. 4 is obviously a linearly separable problem.

After the learning of broken-down subproblems by individual modules, the final solution to the original problem is found by integrating them. The description below focuses on how to integrate modules. (The details of this problem solution, using this module integration technique, are explained in Reference [4].)

For the integration of modules, three units called MIN, MAX, and INV are used. The modules for small learning problems Tᵢⱼ (Eq. 2) and Tᵢⱼ^{(u,v)} (Eq. 4) are denoted by Mₗⱼ and Mₗⱼ^{(u,v)}, respectively.

When solving the K-class problem T (Eq. 1) by dividing it into (K/2) two-class problems Tᵢⱼ (Eq. 2), they are first combined with the MIN unit having the function of selecting the minimum value among the various input values as follows:

MINᵢ=min(Mᵢ₁, . . . , Mᵢⱼ, . . . M_{iK}), i=1, . . . , K(i≠j)

For descriptive convenience, the output is expressed by the MIN unit for modules. The final solution is now provided by as many as K output values in the form of the MIN unit, as follows:

$$C = arg {max}_{i} \{ {MIN}_{i} \} , i = 1 , … , K , \qquad Eq . 6$$

where C represents the class to which the input data belongs. When further breaking down a two-class problem Tₗⱼ into Tᵢⱼ^{(u,v)} (Eq. 4), module Mₗⱼ^{(u,v)} and training Tᵢⱼ^{(u,v)} are fast combined with the MIN unit as follows:

$${MIN}_{i j}^{( u )} = min ( {MIN}_{i j}^{( u1 )} , … , {MIN}_{i j}^{( {uN}_{j} )} ) , u = 1 , … , {N}_{i} , \qquad Eq . 7$$

Module Mₗⱼ is composed by the MAX unit that has the function of selecting the maximum values from the various input values as follows:

$${M}_{i j} = max ( {MIN}_{i j}^{( 1 )} , {MIN}_{i j}^{( 2 )} , … , {MIN}_{i j}^{( {N}_{i} )} ) . \qquad Eq . 8$$

Mₗⱼ created in the above manner is now integrated to Eq. 5. Since the two-class problem Tₗⱼ is the same as Tⱼₗ, Mⱼₗ is composed of the INV unit that inverts Mᵢⱼ and input.

Error detection according to the present invention is carried out online during the learning of a POS tagging problem. Thus, prior to the detailed description of the error detection method, the POS tagging problem itself, how to break down the POS tagging problem, and how the M³ network learns such a problem should be explained.

Suppose that there exist a dictionary V={¹, ², . . . , ^{V}} where the POS that each word can serve is listed and a POS set Γ={τ¹, τ², . . . , τ^{v}}. Then the POS tagging problem is translated into a problem for finding the POS character set T=τ1τ2 . . . τs(τ₁IΓ, i=1, . . . , s) through an operation φ when a sentence W=1 2 . . . S, (₁IV, i=1, . . . , s) is given.

φ: W^{p}→τₚ, Eq. 9

where p is the position of the target word to be tagged in the corpus, and W^{p} is a word sequence where (l,r) represents left and right words, with the target word p placed in their center.

W^{p}=wₚ₋ₗ . . . wₚ . . . wₚ₊ᵣ, Eq. 10

where p−1≧sₛ, p+r≦sₛ+s, with sₛ being the position of the top word in a sentence.

By replacing POS by class, tagging is translated into a classification or mapping problem and can be dealt with by a monitoring neural network that has conducted training on the tagged corpus.

An experiment using the error detection method of the present invention has been carried out to evaluate its performance.

The Kyoto University text corpus (see Reference [6]) used in the experiment contains 19,956 Japanese sentences with 487,691 words, including a total of 30,674 different words.

Reference [6]: Kurohashi, S. and Nagao, M: Kyoto University text corpus project, Proc.3rd Annual Meeting of the Association for Natural Language Processing, pp.115-118, 1997.

More than half the total words are ambiguous in terms of the 175 kinds of POS used in the corpus. It will be determined whether the M network can detect errors online during the learning of a POS tagging problem, and for this purpose 217 Japanese sentences, each of which contains at least one error, have been prepared.

These sentences contain 6,816 words, 2,410 of them being different, and 97 kinds of POS tag. The POS tagging problem is then translated into a 97-class classification problem by replacing POS with class.

Following the calculation method described earlier, this 97-class problemisnowbrokendowntoasmanyas (K/2)=4,565unique two-class problems. Although major problems still remain, they can be further divided by the random method described earlier. As a result, a two-class problem T_{1,2}, for example, is divided into eight subproblems, while T_{5, 10} is not divided further.

In this way, the original 97-class problem has been broken down to 23,231 smaller two-class problems.

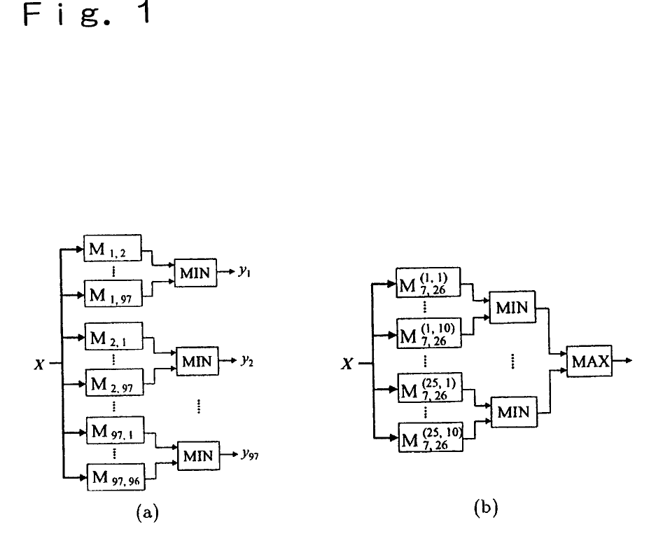

The M³ network that learns POS tagging problems according to the present invention is constructed by integrating modules, as shown in FIG. 1A. Individual modules Mₗⱼ are configured as shown in FIG. 1B if the corresponding problems Tₗⱼ are further divided.

In the example shown in FIG. 1B, problem T_{7,26} is further divided into smaller N₇×N₂₆=25×10=250 subproblems. Thus M_{7,26} is composed of 250 modules,

$${M}_{7 , 26}^{( u , v )}$$

(U=1, . . . , 10) and Mₗⱼ(ⱼ>ₗ) is composed of Mₗⱼ and the INV unit.

The input vector X (for example, Xₗ in Eq. 1) in the learning phase is composed of a word sequence W^{p} (Eq. 10), as follows:

X=(xₚ₋ₗ, . . . , xₚ, . . . , xₚ₊ᵣ). Eq. 11

where element xₚ is a -dimensional binary code vector that encodes the target word.

xₚ=(e_{w1}, . . . , e_{ww}) Eq. 12

Element xₜ(t p)corresponding to each word in context is a τ-dimensional binary code vector for encoding the POS tagged on the word.

xₜ=(e_{τ1}, . . . , e_{ττ}) Eq. 13

The desired output should be a τ-dimensional binary code vector for encoding the POS tagged on the target word as follows:

Y =( Yl)}Y25 .. ) YT ) Eq. 14

Since the problems that the individual modules in the M³ network should learn are very small and simple two-class problems, they can be composed of, for example, very simple multilayer perceptrons, using few or no hidden units. Therefore, as long as the learning data is correct, there is basically no concern for non-convergence problems in the individual modules. In other words, unless a module converges, this module can be regarded as learning the following data set containing some inconsistent data.

$${T}_{M} = {( {X}_{1} , {Y}_{1} )}_{1 = 1}^{LM}$$

This implies that there exists at least one pair of data, (Xₗ, Yₗ) and (Xⱼ, Yⱼ), that satisfies the following relations in this data set.

Xᵢ=Xⱼ, Yᵢ≠Yⱼ(i≠j) Eq. 15

where T_{M} represents Tᵢⱼ (Eq. 2) or Tᵢⱼ^{(u, v)} (Eq. 4).

In this way, such errors in a target tagged corpus can be detected online only by extracting non-convergent modules and checking whether the data contradict each other, namely, by determining with a simple program the (Xᵢ,Yₗ) and (Xⱼ, Yⱼ) pair in the data set learned by the modules and which satisfies Eq. 15.

When using acorpus with high-quality tags, the number of non-convergent modules is more limited than that of convergent ones, and the data set that each module learns is very small. Thus this online error detection method provides a significant cost benefit and its effectiveness is enhanced as the corpus size grows. By adopting such an effective method in error detection, the corpus quality can be improved by simple manual operations during learning, and the updated data can promptly serve the retraining of non-convergent modules.

Embodiment-1 was carried out under the above configuration. The experimental results are described below.

In total, the corpus has 30,674 different words and 175 kinds of POS. The dimensions and τ of the binary code vectors for words and POS are set to 16 and 8. The length of the word sequence (l,r) given to the M³ network is set to (2,2). Then the unit of the input layer becomes [(l+r)×τ]+[1×]=48 in all modules. In principle, all the modules are basically composed of three-layer perceptrons of which input, hidden, and output layers have 48, 2, and 1 units respectively. Modules stop a round of learning when the average square error has reached a goal of 0.05 or calculation has been repeated 5,000 times. Two units of hidden layers are added each round to a module that does not reach the goal for error tolerance, until the goal is accomplished or five rounds of learning are completed.

In the experiment, 82 modules from the total of 23,231 did not converge. Of those 82 modules, 81 modules had exactly 97 pairs of inconsistent learning data. Those 97 pairs of learning data were examined by a specialist with a good understanding of Japanese grammar and the Kyoto University text corpus.

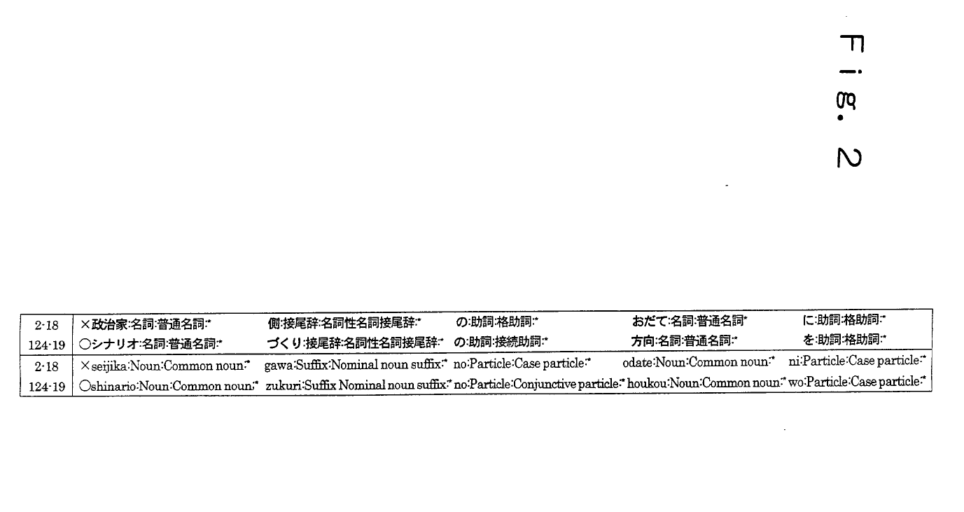

As a result, it was found that 94 out of the 97 learning data pairs contained actual POS errors and the error detection accuracy was close to 97%. FIG.2 shows a non-convergent module,

$${M}_{7 , 26}^{( 1 , 6 )}$$

that is, a pair of learning data detected from the M_{7,26} submodule shown in FIG. 1B. The left column (21) lists the positions of the sentence and the word according to the number assigned to the word. The word sequence shown in the right column (22) is composed of morphemes (minimum language units) delimited by a “,” symbol. Each morpheme has the format of “Japanese word: POS”. The underlined Japanese word is the target word to be checked. The symbol “*” at the beginning of a word sequence indicates that the tag assigned to the target word was wrong.

The other three pairs contradicting each other were also examined and found to be correct. Theywere all cases tagged “de”, working as a postposition or a copulative in various contexts. Since the function of the Japanese postposition “de” is very special, it is hard to determine its rightful POS based only on n-gram words (noun connectives) and POS information. The context of the whole sentence must be taken into account for correct POS tagging.

The experiment indicated that the method of the present invention is capable of detecting POS errors with an accuracy of almost 100%.

In general, the occurrence of non-convergence problem has caused us difficulties in dealing with a neural network. The technique developed according to the present invention, however, has turned this problem into a benefit. This online error detection method shows a significant cost advantage, when adopted in manually tagged corpora. In this way, it has been proven that the error detection method of the present invention works very effectively in detecting errors in text corpora that is an example of large-scale databases.

According to the present invention, only modules expected to have errors are examined for errors in such large-scale databases, of which a typical example is text corpora. Thus there is no need to examine all data, and error detection can be carried out at high speed and with high efficiency. Additionally, errors can be detected with significantly higher accuracy, as shown above.

Since the error detection method of the present invention employs neural network technology that is quite generally applicable, its application area is not limited to error detection in the above-mentioned text corpora.

### Embodiment-2

Embodiment-2 is an application of the present invention to error processing in a database constructed by classifying large scale EEG (electroencephalography) signals in parallel.

In research into the field of neurophysiology, large-scale chronological data, such as EEG data, is produced to record electrical activities of the brain. For analyzing such data, a signal classification technique using a neural network may be employed to construct large-scale databases. The accuracy of the database is of key importance to the brain research, so it is desirable to establish an accurate and high-speed database construction method.

Training of a large-scale network of multi-dimensional EEG data is difficult because there is no efficient algorithm for the training of a large-scale network. Also it takes a long time to carry out training for raising the accuracy level of learning.

To solve this problem, the conventional method uses a small number of characteristics extracted from EEG data as input data. However, if the available number of characteristics is significantly reduced, the EEG signal loses original useful information and the resulting classification rate may prove inaccurate.

The applicants of this invention have proposed a massively parallel EEG signal classificationmethod based on the min-max module (M³)neural network (see Reference [7]).

Reference [7]: Lu, B. L., Ito, M.: Task decomposition and module combination based on class relations: amodular neural network for pattern classification, IEEE Trans. Neural Networks, vol.19, no.5, pp.16-21, 2000.

This method has the following advantages.

a) Large-scale and complex EEG classification problems can be divided into a number of independent subproblems corresponding to user needs.

b) Individual smaller network modules easily learn subproblems in parallel. Thus large sets of multi-dimensional EEG data can be learned efficiently.

c) The classification system runs fast and speeds up calculation in hardware. Thus this system can serve as a hybrid brain-machine interface.

The developed method relies on real-time sampling and large-scale brain activity processing that controls artificial devices.

It is known that the hippocampus EEG signal is related with human recognition processes and behavior, such as attention, learning, and voluntary actions. The following is an embodiment in which the present invention has been applied to practical research.

In this research, we recorded the hippocampus EEG signals of eight male rats that had grown to 300-400 grams in weight. Those rats were given food and water in their individual cages before the start of behavior training. One week after the hippocampus electrodes implant surgery, the rats were denied water and trained by oddball paradigm in a chamber. A few target stimuli were included among repeated non-target stimuli, and the rats had to react to the target stimuli to obtain water.

The target stimulus was a low-frequency sound (unusual sound), while the non-target stimulus was a high-frequency sound (frequent sound). Water was given to the rat as a reward each time the rat successfully reacted to the target sound and crossed a light beam in a water tube.

In total, 2,127 non-average single trial hippocampus EEG signals were sampled from the rats. Each EEG signal lasts six seconds and belongs to the class FR, FW, OR, or OW, where FR represents correct behavior for the frequent sound (no go), FW the incorrect behavior for the frequent sound (go), OR the correct behavior for the unusual sound (go), and OW the incorrect behavior for the unusual sound (no go).

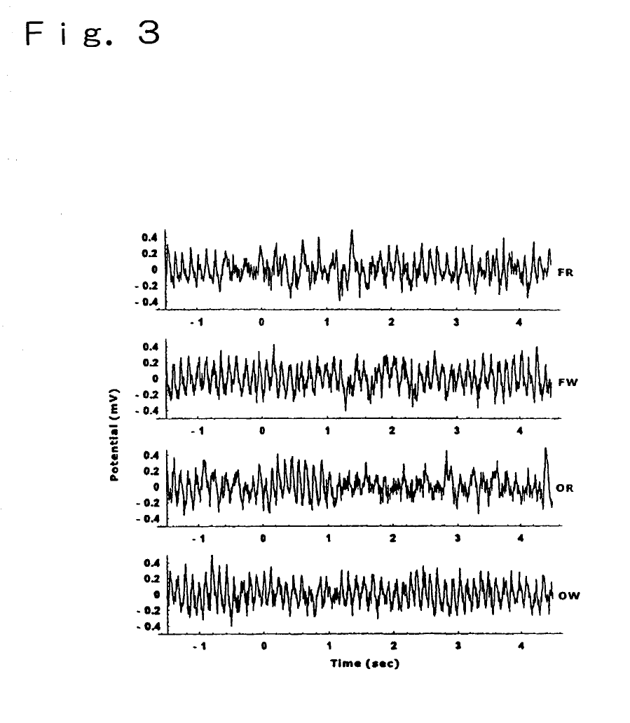

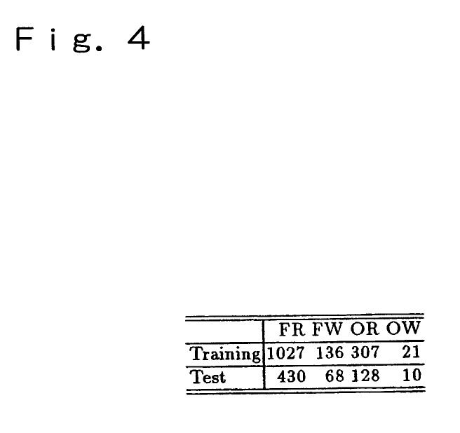

FIG.3 shows the non-average single trial EEG signals belonging to the FR, FW, OR, and OW classes. In simulation, 1,491 EEG signals were used in training and the remaining 636 signals used in a test. FIG. 4 shows the distributions of the training and test data.

In order to quantitatively estimate the changes in amplitude and frequency of the single trial hippocampus EEG signals, a wavelet transform technique (see Reference [8]) is employed and the characteristics in the EEG signals are extracted. Using the Gaussian Morley wavelet ω (t, ωp), the original EEG signal is rotated around its center frequency ω0 in the time and frequency regions.

$$W ( t , {ω}_{o} ) = exp ( j {ω}_{0} t - \frac{{t}^{2}}{2} ) \qquad Eq . 16$$

Reference [8]: Torrence, C., Compoo, C. P.: practical guide to wavelet analysis, Bulletin of the American Meteorogical Society, 1998, Vol.79, pp.61-78

Such a wavelet can be compressed at a compression rate, a, and moved along the time axis by varying a parameter, b. When the signal is rotated, the moved and enlarged wavelet becomes a new signal.

$${S}_{a} ( b ) = \frac{1}{\sqrt{a}} \int W ( \frac{t - b}{a} ) x ( t ) ⅆ t \qquad Eq . 17$$

where W is the conjugation of the complex wavelet and x(t) is a hippocampus EEG signal.

New signals Sa(b) are calculated for various compression rates for a. In order to draw amap of hippocampus theta activities, the characteristics of 5-12 Hz EEG signals were extracted from the time-frequency map.

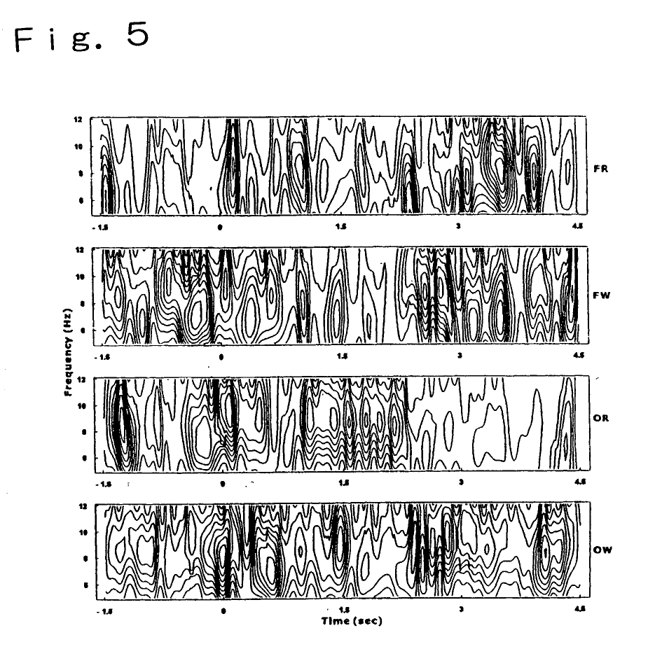

Two data sets were prepared, by varying the number of the sample in the time region, and by using five identical wavelet coefficients within the theta frequency band. There were 200 characteristics in the former set, and 2,000 characteristics in the second data set. FIG. 5 shows contour maps of the time-frequency expression for the 2,000 characteristics of the four EEG signals shown in FIG. 3.

By the task separation method we proposed in Reference [7], a K-class classification problem can be divided into as many as (K/2) two-class subproblems as follows:

$${T}_{ij} = {\{ ( {X}_{l}^{( i )} , 1 - ∈ ) \}}_{I = 1}^{{L}_{i}} ⋃ {\{ ( {X}_{l}^{( j )} , ∈ ) \}}_{l = 1}^{{L}_{j}} \qquad Eq . 18$$

where i=1, . . . , K, j=i+1, . . . , K, ε is a small positive real number, Xₗ^{(I)}*χi and Xₗ^{(j)}*χj are training inputs belonging to class Cᵢ and Cⱼ, respectively, χi is a set of training inputs belonging to class Cᵢ, Lₗ is the number of data included in χi, Σi=1/KLi=L, and L is the total number of pieces of training data.

If there is a two-class problem defined by Eq. 18 that is still too large for learning, the problem can be further broken down to a number of smaller two-class problems according to user needs. Suppose that χi is divided into subsets Ni (1≦Ni≦Li) of the following form:

$${x}_{ij} = {\{ {X}_{l}^{( ij )} \}}_{l = 1}^{{L}_{i}^{( j )}} , j = 1 , … , {N}_{i} , \qquad Eq . 19$$

where J=1, . . . , Ni, i=1, . . . , K, and Uj=1/Niχij=χi. Through the above χi division, the two-class problem τij defined by Eq. 18 can be further broken down to as many as (Ni×Nj) smaller and simpler two-class subproblems as follows:

$${T}_{ij}^{( u , v )} = {\{ ( {X}_{l}^{( iu )} , 1 - ∈ ) \}}_{l = 1}^{{L}_{i}^{( u )}} u {\{ ( {X}_{l}^{( jv )} , ∈ ) \}}_{l = 1}^{{L}_{j}^{( v )}} \qquad Eq . 20$$

where u=1, . . . , Ni, i=1, . . . Nj, i=1, . . . , K, and j=i+1, . . . , K; Xₗ^{(lu)}*χiu and χₗ^{(Jv)}*χjv are training inputs belonging to class Cᵢ and Cⱼ respectively.

Eqs. 18 and 20 indicate that a K-class problem can be divided into as many as Σi=1/KΣj=i+1/KNi×NJj two-class subproblems by the top-down approach.

Eq. 18 indicates that a 4-class EEG classification problem can be broken down to (4/2)=6 two-class subproblems, namely, τ1, 2, τ1, 3, τ1, 4, τ2, 3, τ2, 4, and τ3, 4. FIG. 4 shows that there are 157 items of training data in the minimum two-class subproblem τ2, 4, while there are 1,334 items in the maximum two-class subproblem τ1,3.

In order to accelerate learning, relatively large subproblems are further divided into smaller and simpler subproblems. Using Eq. 19, the three large input data sets belonging to the FR, FW, and OR classes are randomly broken down to 49, 6, and 15 subsets, respectively.

As a result, the original four-class problem is divided into as many as Σi=1/4ΣJ=i+1/4Ni×Nj=1,189 balanced two-class subproblems, where N1=49, N2=6, N3=15, and N4=1. There are approximately 40 items of training data in each problem.

An important feature of the proposed task division method is that each of the two-class subproblems can be treated as a completely independent, non-communicating subproblem in the learning phase. Consequently, all of the subproblems can be learned in parallel.

In comparison with the conventional method, this massively parallel learning approach has the advantage of being easily applicable not only to common parallel computers but also individual serial machines as well as a number of distributed Internet applications.

After training each of the modules, all of the individual network modules can be easily integrated into an M³ network by using the MIN, MAX, or/and INV units according to the minimization and maximization module combination principles.

In this manner, such a large-scale database as hippocampus EEG signals can also be integrated to the M³ network. It is then possible to adopt the error detection method of the present invention in the learning process.

Since the problems that the individual modules in the M³ network have to learn are very small and simple two-class problems, they can be constructed by very simple multilayer perceptrons with a few or no hidden units. Therefore, there is basically no concern that the problem of non-convergence will occur in the individual modules as long as the learning data is correct.

Taking advantage of this property, it becomes possible to detect errors while learning data just as in the case of error detection in the aforementioned text corpus and analyze EEG signals with high accuracy, thereby contributing to progress in the research of neurophysiology.

The online error detection method of the present invention using a neural network can be applied to any field, and its high speed of operation is a feature that is not seen in conventional methods.

### Advantageous Effect of the Invention

This invention, with the aforementioned configuration, provides the following utilities.

According to the data error detection method outlined in claim 1, it becomes possible, through the examination of non-convergent modules, to efficiently detect errors contained in a manually made database during the learning process. Therefore, non-convergence often encountered in a neural network is turned from a problem into a benefit.

Thus a fast, highly accurate, and low-cost error detection apparatus can be realized.

The data error detection apparatus outlined in claim 2 can detect errors in databases at a speed rarely attained by conventional systems. This apparatus can be installed in the database system, for example, learning the database and carrying out online error detection.

Thus a fast, highly accurate, and low-cost error detection apparatus can be realized.

According to the data error detection software outlined in claim 3, it is possible to efficiently detect errors contained in a manually made database during the learning process by examining non-convergent modules. Therefore, non-convergence often encountered in a neural network is turned from a problem into a benefit. In addition, because the present invention is provided in the form of software, it can be easily utilized.

If the memory medium for data error detection software outlined in claim 4 is employed, it becomes easy to distribute this software program for widespread use. In addition, this medium holding the error detection software program contributes to the construction of an inexpensive memory unit.

What is claimed is:

1. A data error detection method for a database containing at least two kinds of data and in which one kind of data can be classified by another kind of data. The detection method consists of the following steps:
treating the classification as a class in a neural network;
dividing the classification problem into smaller two-class problems for a plurality of modules;
making calculations to check whether or not each of the said modules converges in the learning process in the neural network; and,
regarding said module having pattern classification errors in the case of convergence failure, extracting it.

2. A data error detection apparatus for a database containing at least two kinds of data and in which one kind of data can be classified by another kind of data. The apparatus consists of the following:
a means for memorizing said database;
a means of calculation for treating the classification as a class in a neural network, dividing the classification problem into smaller two-class problems for a plurality of modules, checking whether or not each of the said modules converges in the learning process in the neural network; and
a means of error extraction for regarding said module as having pattern classification errors in the case of convergence failure and extracting it.

3. A data error detection software program for a database containing at least two kinds of data and in which one kind of data can be classified by another kind of data. The detection program consists of the following steps:
treating the classification as a class in a neural network and dividing the classification problem into smaller two-class problems for a plurality of modules;
making calculations to check whether or not each of the said modules converges in the learning process in the neural network; and
regarding said module as having pattern classification errors in the case of convergence failure and extracting it.

4. A medium storing a data error detection software program for a database containing at least two kinds of data and in which one kind of data can be classified by another kind of data. The program consists of the following:
a memory unit treating the classification as a class in a neural network and dividing the classification problem into smaller two-class problems for a plurality of modules;
a memory unit making calculations to check whether or not each of the said modules converges in the learning process in the neural network; and
a memory unit regarding said module as having pattern classification errors in the case of convergence failure and extracting it.
